(19) United States
(12) Patent Application Publication
(10) Pub. No.: US 2013/0186347 A1
(43) Pub. Date: Jul. 25, 2013

(54) Cultivation of sustainable aquatic organisms using multitrophic closed systems

(71) Applicant: Jessica Ann Stephens, Albuquerque, NM (US)

(72) Inventor: Jessica Ann Stephens, Albuquerque, NM (US)

(21) Appl. No.: 13/745,841

(22) Filed: Jan. 20, 2013

Related U.S. Application Data
(60) Provisional application No. 61/589,377, filed on Jan. 22, 2012.

(51) Int. Cl. A01K 61/00

(52) U.S. Cl. CPC A01K 61/00
USPC 119/260; 119/245

(57) ABSTRACT

A multitrophic, inland aquaculture system allows for the cultivation of aquatic animals as a food source and the cultivation of algae for use as biofuel and biomass in a sustainable manner based on the symbiotic nature of the organisms grown. This unique process minimizes biological, energy, and water inputs to create a highly sustainable system by utilizing the cyclic conversion of oxygen to carbon dioxide and back to oxygen as well as using the biological waste from aquatic food organisms to provide nutrients for algae organisms for the benefit of both species. This enables the cultivation of food species in higher densities than previously possible, and eliminates the need to provide additional nutrients, water, and non-atmospheric carbon dioxide for algal growth.

### CROSS-REFERENCE TO RELATED APPLICATIONS

This application claims the benefit of provisional patent application No. 61/589,377, filed 2012 Jan. 22 by the present inventor.

### FEDERALLY SPONSORED RESEARCH

None

### SEQUENCE LISTING

None

### BACKGROUND

1. Field of the Invention

This relates to the inland, sustainable cultivation of aquatic food sources and algae for biomass and renewable fuel. This two-part system balances the needs and waste products of algae and aquatic food animals to provide a closed system, so that the waste from one organism provides the nutrient sources for the other. Aquatic animals excrete biological waste, including nitrogen and other compounds, and produce carbon dioxide. Algae utilize both in the process of growth and photosynthesis, while producing oxygen and removing the waste; this process returns water to a suitable state for marine and freshwater animals to breed and grow in.

2. Description of Problem Solved by this Invention

Marine and freshwater animals provide a critical food source for the world's ever-increasing population, but wild sources are limited, and catches have been decreasing steadily for decades. Farming of these animals, referred to as aquaculture, can supply a steady source, but modern aquaculture faces many problems. For example, coastal shrimp farms in Asia supply much of the world's cultivated shrimp, but these farms are responsible for significant loss of habitat, as well as serious pollution and contamination of local resources. Even modern recirculating systems waste significant amounts of water and contaminate ground water with water that is high in biological waste and often saline. Cultivation of aquatic species in densities high enough to provide a sufficient food source results in the rapid accumulation of biological waste and carbon dioxide and the depletion of oxygen, which contaminates the water and poisons the animals. In current aquaculture systems, this requires continuously draining and replacing water, which pollutes the surrounding area and wastes a scarce resource. Coastal farms in Asia destroy local habitat in order to provide ponds to grow shrimp.

Open systems create many ecological hazards. Local habitat is destroyed for the process, first by removing the natural habitat, and ultimately through the contamination of the area with saline water and biological waste. There is also risk of escape from the ponds, and therefore introduction of non-native species. The cultivation of shrimp in high densities also increases the risk of disease outbreak and possible spread to the native wildlife. Additionally, many shrimp farms do not produce their own shrimp, but instead collect young shrimp (larvae) from the wild and raise them in the ponds; this, therefore, does not decrease the strain on wild populations.

Recirculating aquaculture systems rely on various chemical and filtration means to remove some of the nitrogenous waste from the water, thereby reducing somewhat the water demands of the system. However, they do not use a system which can eliminate the need for copious amounts of water. This demand means that current aquaculture systems cannot be employed in arid environments. Since the waste products are not completely removed from the water, there is still waste water with high amounts of contaminants, such as salt and nitrogen. These systems also rely on culturing these animals in very high densities, which increases the risk of disease outbreak, potentially eliminating an entire crop. Similar types of disadvantages face the developing industry of algaculture for biomass and biofuel.

As the world's source of oil and coal decreases, but demand increases, the solution is the cultivation of plant-based oil sources. Current production focuses on corn, rapeseed, etc., but algae contain a higher percentage of lipids for the production of biofuels.

Current production of plants for creation of biofuels requires land that is suitable for growing food sources, thereby reducing the amount of arable land available to produce food for human consumption. Growing these crops also requires large amounts of water and other fertilizers. Algae produce more oil by percentage of weight than land-based crops such as corn, and can be grown on land that is not suitable for crop growth. However, as it grows, the algae quickly deplete the water of nitrogen and carbon dioxide and saturate it with oxygen. Therefore, in order to cultivate algae, replacement water and fertilizer sources are needed. Closed systems that use a photobioreactor are preferable to pond systems that allow the introduction of contaminant bacteria and other organisms and face massive evaporation, especially in arid environments. However, use of a photobioreactor introduces other problems, such as identifying and providing a source of carbon dioxide, as well as other fertilizers needed by the algae to grow. Algae farms also require and waste large amounts of water.

In conclusion, although there are existing systems of aquaculture and algaculture, insofar as I am aware, there are no multitrophic, closed systems that balance the needs and wastes of the two organisms, significantly eliminating the disadvantages present in both processes.

3. Description of Prior Art

U.S. patent application Ser. No. 13/271,622 relates to a space efficient photo-bioreactor. The bioreactor grows microalgae in a tall array of transparent flooded tubes. A nutrient media is circulated through the tubes. The array is configured to maximize the amount of sunlight falling upon each tube so that growth of the microalgae is as uniform as possible. Gassing/degassing systems are attached to the array of tubes at appropriate locations. These introduce carbon dioxide and remove oxygen. Cooling systems are preferably also provided so that the circulating media can be maintained at a desired temperature. Microalgae are harvested from the photo-bioreactor. The microalgae is filtered and dried. Lipids are then extracted from the microalgae. These lipids are made into biodiesel through a trans-esterification process. The lipids may be used to make other products as well.

This invention requires the introduction of nutrient media and the use of gassing/degassing systems, and it also requires the use of cooling systems resulting in higher costs. There is no stated use of the biomass that results as a byproduct of the lipid extraction process.

U.S. Pat. No. 6,851,387 relates to an invention that provides a method and system for producing aquatic specie for consumer consumption within a closed aquaculture system. It provides for growing algae in artificial saltwater under controlled conditions in an algae subsystem, feeding the algae to adult artemia for producing small artemia in an artemia subsystem, feeding the algae and small artemia to immature aquatic specie for producing adolescent aquatic specie in an aquatic specie nursery subsystem, and feeding the algae and small artemia to the adolescent aquatic specie to for producing adult aquatic specie in an aquatic specie growout subsystem, which are then harvested. The invention also includes a data acquisition and control subsystem for automated control of the aquaculture system. A unique filtration subsystem accepts waste from the aquatic specie subsystem, pumps the waste through a series of filters, and returns the filtered saltwater to the algae subsystem, the artemia subsystem and the aquatic specie subsystem.

The algae species grown in the system are not specified as high lipid content algae. The algae grown is used only as a food source for the artemia, wasting the valuable resource (lipids) that is produced as the algae photosythesize.

U.S. Pat. No. 6,327,996 relates to a Biosecure zero-exchange system for maturation and growout of marine animals. A system and a method of growing shrimp, allowing balanced processes to accomplish the intensive culture of shrimp while reducing the risk of loss due to disease or environmental contaminants. Specifically, the present invention involves a unique combination of elements including: the use of specific pathogen free marine animal stocks, facilities which are effectively disinfected and isolated from sources of disease vectors and environmental contaminants, a beneficial, synergistic microbial population, and an aqueous medium of controlled composition. The system also comprises a specialized feed for supporting the microorganisms and marine animals, with zero-exchange of aqueous medium throughout the growout cycle such that the solids formed during operation, uneaten feeds, and fecal matter are retained in the system to provide an environment suitable for high yields and growth rates of marine animals.

Retaining the solids produced in operation, such as uneaten foods and fecal matter, will prove toxic to the growing marine animals without an added component to break down these products into a non-toxic form.

U.S. Pat. No. 8,291,640 relates to an aquaponic facility with closed water circulation, including at least one aquaculture unit and at least one hydroponic unit, characterized in that the aquaculture unit has at least one water outlet which is functionally connected with the hydroponic unit by a one-way valve such that water from the aquaculture unit can be supplied to the hydroponic unit, and the hydroponic unit has at least one cold trap, wherein the at least one cold trap is functionally connected with the aquaculture unit in such a way that the water obtained from the at least one cold trap can be supplied to the aquaculture unit, as well as its use.

The plants grown in hydroponic units in this system require considerable water thereby limiting the amount of water available for return to the aquaponic unit. The hydroponic unit is open to air requiring the use of cold traps to condense and collect water for return to the aquaponic units. The amount of water available will be climate dependent and this unit will not work well in arid environments. The hydroponic system does not return nutrients to the aquaponic unit thereby requiring the introduction of all nutrients needed by the aquatic organisms grown in the unit.

### SUMMARY OF THE INVENTION

This multitrophic, inland aquaculture and algaculture system allows the cultivation of aquatic animals as a food source, utilizing a closed, nearly-waste-free system, while producing algae which can be used for biomass and biofuel production. This closed system enables the cyclic exchange of oxygen and carbon dioxide for the benefit of both organisms, enabling the cultivation of food species in higher densities than previously possible, and eliminating the need to provide additional, non-atmospheric, carbon dioxide for algal growth. Aquatic animals, such as shrimp, sardines, etc., will be raised in a tank containing water adjusted to meet their specific needs, such as artificial seawater. Water will be pumped out of the tank into a photobioreactor that is suspended above the tank to ensure maximum ultraviolet radiation. Biological waste produced by the growing aquatic animals will be pumped into the photobioreactor where it will provide the nutrients necessary for algal growth. The water will be pumped from the tank and through the photobioreactor at a low flow-rate in order to provide the algae maximum opportunity to remove the waste from the water and replace oxygen, thereby ensuring a constant supply of waste-free water and limiting the need to replenish water.

In the photobioreactor(s), we will cultivate algae for the purpose of producing biofuel and biomass. These algae will feed on the biological waste and utilize the carbon dioxide produced by the aquatic animals being cultivated, thereby eliminating the biological waste and removing the carbon dioxide, which is used during photosynthesis, and reoxygenating the water. This balance eliminates the need to identify and provide an outside source of carbon dioxide for photosynthesis, as well as additional fertilizers to provide nutrients.

Nutrients and necessary gasses are produced naturally within the system described in this invention. The production within a contained, biosecure environment largely negates the need for costly cooling measures. Biomass resulting from the lipid extraction will serve as a biosecure food source for aquatic animals raised in this system.

Algae grown using this invention are high in lipids, which are harvested to produce biofuel, In this way, both biomass and lipids are fully utilized.

Algae production serves to utilize and remove organic solids such as uneaten foods and fecal matter produced in the growth of aquatic animals in this system.

Since the water solely circulates within a contained, multitrophic unit, very little water is lost from the unit. Due to diminished water usage and loss, this system is not climate dependent. Denitrified, oxygenated water from the photobioreactors returns to the tank growing the aquatic animals raised in this system.

### BRIEF DESCRIPTION OF THE DRAWINGS

FIG. 1 is a side view of the integrated tank and photobioreactor system.

### REFERENCE NUMERALS

11 aquatic organism tank

12 nutrient flow tube

13 photobioreactor

14 outtake valve

15 harvesting tubes

16 intake valve

17 algae collection net

18 water reservoir

19 filter

20 pump

21 flexible return hose

22 oxygenated water return tube

23 algae harvest valve

24 algae harvest valve

25 algae harvest valve

### DETAILED DESCRIPTION OF THE INVENTION

### 1. Definitions

Algaculture, as used herein shall mean, the cultivation of algae, as defined herein.

Algae, as used herein shall mean, any species of algae, diatoms, and cyanobacteria which are autotrophic.

Aquaculture, as used herein shall mean, the cultivation of aquatic animals.

Biosecure, as used herein shall refer to one or more systems or components that serve to minimize or eliminate introduction of outside contaminants including living organisms, pathogens or debris.

Gasses, as used herein, shall refer specifically to dissolved oxygen and carbon dioxide

Multitrophic, as used herein shall mean, two or more living elements of which one is a food source for the other.

Nutrients, as used herein, shall mean the biological compounds needed in the growth of algae and aquatic animals

### 2. Best Mode of the Invention

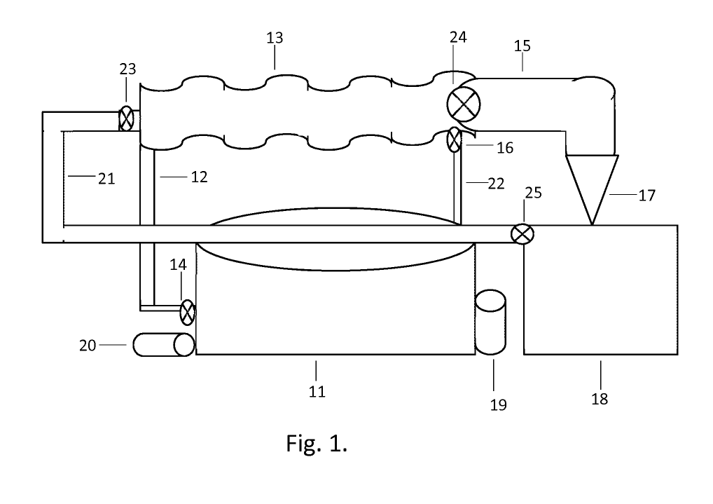

FIG. 1 shows a side view of the best mode contemplated by the inventor of an integrated tank and photobioreactor system according to the concepts of the present invention.

### 3. How to Make the Invention

FIG. 1 is a side view of the multitrophic aquaculture system which illustrates the embodiment of this invention. The system has multiple components: tank, photobioreactor(s), algae net(s), water reservoir(s), pump(s), valve(s), filter(s), and connective plumbing. Aquatic animals are grown in a tank (11), the specifications of which will depend on the species being cultivated, and their biological requirements. For example, shrimp species will be cultivated in round tanks, no more than three feet deep, since there is little need for swimming space. As the animals grow, they will produce organic waste, which would ordinarily pollute the water. Water will pass through a filter (19) before leaving the tank, in order to remove large waste material that cannot be utilized by the algae. Pumps (20) will move the water, which is high in biological wastes and carbon dioxide, out of the tank and up into the photobioreactor (13) via the nutrient flow tube (12).

The diameter of the photobioreactor (13) will be adequate to provide the needed flow rate to supply nutrients to the algae and not exceed ideal water movement for the aquatic species. As the water moves through the photobioreactor (13), the algae will remove the organic waste, utilizing this to grow, as well as the carbon dioxide produced by the animals during respiration, which will be used in the process of photosynthesis. Water will be returned to the tank (11) via the oxygenated water return tube (22) after the algae have removed waste products and added oxygen, and the water is therefore suitable for the cultivation of animals. When the algae has grown enough to be harvested, the flow rate to and from the tank will be cut off via intake and outtake valves (14 & 16), and water from a reservoir (18) located by the tank will be used to wash the algae out of the photobioreactor (13) using a flexible return hose (21) and algae harvest valves (23, 24, &25), through the harvesting tube(s) (15) and into the algae collection net (17). Water will flow through the net (17) and return to the water reservoir (18) for future use, while the algae will be collected in the net (17) to be removed and processed for the creation of renewable energy sources and production of biomass.

### 4. Operation

In operation, the user adds immature aquatic animals to the tank, and feeds the animals to encourage growth. As the animals grow, they produce waste, which would ordinarily pollute the water; however, in this system, the water is pumped out of the tank and passes through a filter that removes large waste material that cannot be utilized by the algae. The water containing biological waste and carbon dioxide will be pumped into the photobioreactor to provide compounds needed for photosynthesis. As algae photosynthesize, carbon dioxide and nitrogenous compounds will be removed from the water and replaced with the oxygen produced during photosynthesis, which is needed by the aquatic animals for respiration. This replenished water will be returned to the aquatic animal tank. This process will cycle until the aquatic animals mature for sale. The algae will be harvested throughout the cycle when needed to provide the optimal balance to recycle biological waste, carbon dioxide and oxygen. To harvest the algae, the recirculating system will be closed and the photobioreactor will be flushed with water and the algae captured in the algae collection net. The algae will be transferred to the processing plant and the system will be reopened. Upon reaching maturity, the aquatic animals are harvested for consumption and replaced with new immature animals.

Thus it will be appreciated by those skilled in the art that the present invention is not restricted to the particular preferred embodiments described with reference to the drawing, and that variations may be made therein without departing from the scope of the present invention as defined in the appended claims and equivalents thereof.

1. A closed, multitrophic aquaculture system composed of:
a tank of water for the cultivation of aquatic animals, and
an attached photobioreactor for the cultivation of algae for biofuel and biomass,
whereby the system recirculates water, biological waste, carbon dioxide and oxygen, significantly reducing the need for addition of water and fertilizers.

2. The system of claim 1, wherein the tank of water is used for growing aquatic animals from brood stock for food and pharmaceutical purposes and for supplying nutrients and gasses required by the algae grown in the photobioreactor in claim 1.

3. The system of claim 1, wherein the tank of water is connected to the photobioreactor described in claim 1 by a serious of tubes and one-way valves to create a recirculating system of nutrients, gasses, and water.

4. The system of claim 1, wherein the photobioreactor is used for culturing various species of algae and receiving required nutrients, gasses, and water from the tank of water and recirculating system of claim 1.

5. The connected photobioreactor of claim 4, wherein the algae grown in the photobioreactor is suspended in an aqueous solution whereby, upon reaching maturation, the algae is extracted from the water through a filter apparatus which is also connected to the water tank, allowing the water, which has been oxygenated and denitrified, to be returned directly to the tank of water used in cultivation of aquatic animals.

6. The system of claim 1, wherein the aquatic animals grown in the tank of water of claim 1 are harvested at maturation for sale as food for human and/or animal consumption, with any unusable product returned to the tank of water as additional nutrients for the aquatic animals grown in the tank of water.

7. The system of claim 1, wherein the photobioreactor is used for growing algae that, when extracted from the aqueous solution, is further compressed by industry available centrifuges into lipids for biofuel, but also produces a biomass byproduct that is returned as a food to the tank of claim 1, and any remaining biomass can be sold as an ingredient in pet food, as well as a food source for future growth cycles of aquatic animals within the unit.

8. The system in claim 1, which is housed in a greenhouse to provide needed light and dark cycles for algae growth, provides a biosecure environment limiting the risk of disease negatively impacting the aquatic animal and/or the algae populations.

9. The system of claim 1, wherein multiple separate systems are all housed within one or more greenhouses to limit the risk of infection and/or mechanical breakdown.

10. The system of claim 1, which is housed within a biosecure greenhouse to provide needed light and dark cycles for algae growth and provide a biosecure environment for growth, and also limits the need for excessive heating and cooling systems, as the environment will be moderately climate controlled.
